(19) United States
(12) Patent Application Publication
(10) Pub. No.: US 2017/0122132 A1
(43) Pub. Date: May 4, 2017

(54) Waste Management

(71) Applicant: Chinook End-Stage Recycling Limited, Nottinghamshire (GB)

(72) Inventors: Rifat Al CHALABI, Nottinghamshire (GB); Ophneil Henry PERRY, Nottinghamshire (GB); Ke LI, Nottinghamshire (GB)

(73) Assignee: Chinook End-Stage Recycling Limited, Nottinghamshire (GB)

(21) Appl. No.: 15/315,967

(22) PCT Filed: Jun. 2, 2015
(86) PCT No.: PCT/GB2015/051604

§ 371 Date: Dec. 2, 2016

(30) Foreign Application Priority Data
Jun. 3, 2014 (GB) 1409857.8

(51) Int. Cl. F01K 23/06; H02K 7/18; F01K 13/00; F01K 25/14; F01K 13/02

(52) U.S. Cl. CPC F01K 23/067; F01K 25/14; F01K 13/02; F01K 13/003; H02K 7/1823; H02K 7/1815

(57) ABSTRACT

The present invention relates to a method for producing steam, the method comprising: (a) passing waste gas through a first boiler to produce steam having a first temperature, and cooled waste gas; (b) removing contaminants from the cooled waste gas to produce clean waste gas; (c) passing the steam having a first temperature through a second boiler; and (d) burning at least a portion of the clean waste gas in the second boiler to produce steam having a second temperature, the second temperature being higher than the first temperature. The method is particularly suited to efficiently generating high temperature, high pressure steam derived from the pyrolysis/gasification of organic waste.

The present invention relates to the production of steam from waste gas, more particularly to a method and a system for producing high temperature, high pressure steam from waste gas.

### BACKGROUND TO THE INVENTION

Waste gases are produced by the pyrolysis or gasification of industrial or municipal solid waste. It is desirable to recover both the chemical energy and the heat energy present in the waste gas to maximize energy efficiency.

The corrosive nature of the waste gas imposes significant challenges for heat recovery, since it shortens the lifetime of heat exchangers, increases the frequency of maintenance and shut-down time, and limits the heat recovery efficiency and overall plant efficiency. To minimize degradation of the heat exchangers caused by the corrosive gases, the temperature within heat recovery boilers is restricted. High pressures are also conventionally avoided in order to minimize the stresses placed on the pipes.

In order to maintain reliability of heat recovery equipment, a common practice in the industry is to select a low pressure and low temperature boiler for the production of steam. A consequence of this, however, is the low efficiency of turbines driven by low temperature, low pressure steam. This not only makes the heat recovery equipment inefficient, but also decreases the total plant output, and makes waste-to-energy projects less economically viable.

It is an object of the present invention to mitigate at least some of the problems identified above.

### SUMMARY OF THE INVENTION

According to a first aspect of the present invention, there is provided a method for producing steam, the method comprising:

(a) passing waste gas through a first boiler to produce steam having a first temperature, and cooled waste gas;

(b) removing contaminants from the cooled waste gas to produce clean waste gas;

(c) passing the steam having a first temperature through a second boiler; and

(d) burning at least a portion of the clean waste gas in the second boiler to produce steam having a second temperature, the second temperature being higher than the first temperature.

It will be understood that ‘waste gas’, as used herein, is a product of the gasification of organic material, such as municipal waste or other organic-containing waste materials, and comprises mainly a mixture of hydrogen, carbon monoxide carbon dioxide and some methane. The waste gas may also be referred to as syngas. Raw waste gas (i.e. the direct product of gasification) typically contains chemical contaminants, such as chlorine and sulphur compounds and sticky particles, which are corrosive to heat recovery equipment.

In some embodiments, the method further comprises an initial step of gasifying waste organic material to produce waste gas.

The waste gas used in step (a) may have a temperature of at least 400° C., at least 500° C. or at least 600° C.

In step (a) the waste gas is passed through a first boiler wherein heat transfer takes place between the hot waste gas and water, producing steam. This process also functions to reduce the temperature of the waste gas, thereby producing cooled waste gas.

It may be convenient to maintaining the first temperature of the steam obtained in step (a) at or below a predetermined threshold. This helps to minimize corrosion of the equipment by contaminants present in the waste gas. Thus, in some embodiments, the method comprises monitoring the first temperature and/or the pressure of the steam obtained in step (a). In some embodiments, the method further comprises controlling the first temperature and/or pressure of the steam obtained in step (a). The pressure of the steam may be controlled by, for example, controlling the pressure of the water supply. The first temperature of the steam may be controlled by restricting the quantity and/or temperature of the waste gas passed through the first boiler.

In some embodiments, the steam has a first temperature of no more than 400° C., no more than 350° C., no more than 320° C., no more than 300° C. or no more than 250° C.

In some embodiments, the steam produced in step (a) has a pressure of at least 40 bar, at least 50 bar or at least 60 bar (e.g. about 65 bar). It has surprisingly been found that, provided the first temperature is maintained at or below a predetermined threshold, the pressure of the steam can be increased relative to conventional pressures without any detrimental effect on the equipment.

In further embodiments, the first temperature of the steam is equal to or just below the saturation temperature of the steam at the selected steam pressure. For example, the steam may have a pressure of about 65 bar and a first temperature of about 280° C.

It may be considered that the steam produced in step (a) has a relatively high pressure and a relatively low temperature.

In step (b), the cooled waste gas produced in step (a) is treated to remove contaminants. In some embodiments, step (b) comprises passing the cooled syngas obtained in step (a) through a gas clean-up apparatus, thereby obtaining clean waste gas. The types of clean up apparatus are well known to the skilled person and include, but are not limited to dry scrubbing apparatus with reagent dosing and wet scrubbing systems with pH control.

In step (c), the steam produced in step (a) is passed through a second boiler where it is heated by burning at least a proportion of the clean waste gas (step (d)), thereby producing steam having a second temperature which is higher than the first temperature.

In some embodiments, the second temperature is at least 450° C., at least 500° C., or at least 550° C. It may be considered that the steam produced in step (d) has a relatively high pressure and a relatively high temperature.

In step (d), the quantity of clean waste gas burned in the second boiler may be sufficient to heat the steam to a temperature of at least 450° C., at least 500° C. or at least 550° C.

Since only clean waste gas is burned, there are fewer contaminants in the gas that can cause corrosion of equipment such as heat exchange tubes of a boiler, thereby prolonging the lifetime of the equipment.

The method of the invention thus enables the production of high quality steam having both a relative high pressure and a relatively high temperature. High temperature, high pressure steam can be used to drive turbines with greater efficiency.

In some embodiments, the method comprises burning a first portion of clean waste gas in the second boiler and supplying a second portion of clean waste gas to power generation equipment, such as an internal combustion engine or a gas turbine, for the direct production of electricity. The method may further comprise adjusting the ratio of the first portion of clean waste gas supplied to the second boiler to the second portion of clean waste gas supplied to the power generation equipment.

The chemical energy present in the waste gas is recovered by the power generation equipment, while the sensible heat energy in the waste gas is recovered through steam production. It will be appreciated that the more clean waste gas is burned to heat the steam in the second boiler, the less clean waste gas is available for direct electricity production. The distribution of clean waste gas between the power generation equipment and the second boiler is therefore balanced so as to achieve maximum efficiency. The method of the invention thus enables the waste gas to be managed to recover as much energy as possible.

The power generation equipment may release hot exhaust gases. In some embodiments, the method additionally comprises passing exhaust gases from the power generation equipment through a third boiler, thereby obtaining a second batch of steam and cooled exhaust gases. This enables recovery of the heat energy present in the hot exhaust gases, and maximizes efficiency.

The second batch of steam produced by the third boiler may have a third temperature which is lower than the second temperature. In some embodiments, the method further comprises passing the second batch of steam through the second boiler. In further embodiments, the second batch of steam is combined with the steam obtained in step (a) before passing the steam through the second boiler.

In some embodiments, the temperature within the second boiler is at least 700° C., at least 750° C., at least 800° C. or at least 800° C.

In some further embodiments, the cooled exhaust gases produced by the third boiler are supplied to the second boiler where they are burned. This oxidizes any volatile organic pollutants present (including carbon monoxide) in the exhaust gases, thereby reducing the quantity of pollutants released to the atmosphere and making the process more environmentally friendly.

Flue gases from the second boiler may be released to a stack.

In some embodiments, the method further comprises using the steam obtained in step (d) to drive a turbine to generate electricity.

Thus, in some embodiments, the method comprises:

passing waste gas through a first boiler to produce steam having a first temperature, and cooled waste gas;

removing contaminants from the cooled waste gas to produce clean waste gas;

passing the steam having a first temperature through a second boiler; and

supplying a second portion of the clean waste gas to a power generation equipment, thereby obtaining electricity and hot exhaust gases;

passing the hot exhaust gases through a third boiler to produce a second batch of steam having a third temperature, and cooled exhaust gases;

passing the second batch of steam having a third temperature through the second boiler;

burning a first portion of the clean waste gas in the second boiler to produce steam having a second temperature, the second temperature being higher than the first and third temperatures; and,

optionally, burning the cooled exhaust gases in the second boiler to oxidize pollutants present therein.

According to a second aspect of the present invention, there is provided a waste-to-energy system comprising:

a reactor for gasifying organic waste to produce waste gas;

a first boiler comprising a gas inlet, a water inlet, a gas outlet, and a steam outlet;

a cleaning apparatus;

a second boiler comprising a gas inlet, a gas outlet, a steam inlet and a steam outlet; and

a steam turbine comprising a steam inlet,

wherein a flow path for gas is provided from the reactor to the second boiler via the first boiler and the cleaning apparatus, and a first flow path for steam is provided from the first boiler to the steam turbine via the second boiler.

The gas inlet of the first boiler receives waste gas released by the reactor. The first boiler recovers heat from the waste gas by heating water to produce steam and cooled waste gas.

The cleaning apparatus is for removing contaminants from the cooled waste gas released by the first boiler, to produce clean waste gas. The cleaning apparatus may comprise a gas inlet, which is fed by the gas outlet of the first boiler, and a gas outlet.

The second boiler is for heating the steam produced by the first boiler by burning clean waste gas received from the cleaning apparatus. The gas inlet of the second boiler may be connected to the gas outlet of the cleaning apparatus. The steam inlet may be connected to the steam outlet of the first boiler. The gas outlet of the second boiler may be connected to a stack for the release of flue gases.

In some embodiments the gas flow path is branched at or just after the cleaning apparatus, wherein a first branch is provided between the cleaning apparatus and the second boiler, and a second branch is provided between the cleaning apparatus and a power generation unit. The power generation unit may be an internal combustion engine or a gas turbine. The power generation unit may comprise a gas inlet and a gas outlet. The gas inlet of the power generation unit may be connected to the gas outlet of the cleaning apparatus. This arrangement enables at least a portion of the clean waste gas produced by the cleaning apparatus to be diverted to the power generation unit for generating electricity.

In some embodiments, the system further comprises a controller for controlling the distribution of gas between the first and second branches. The controller may comprise a valve positioned at the point at which the first flow path branches. The controller may be manually operable. In some embodiments, the controller may be operated by a control unit which is capable of automatically adjusting the distribution of gas flow between the first and second branches.

In some embodiments, the second branch is provided from the cleaning apparatus to the second boiler, via the power generation unit.

In some embodiments, the second branch additionally passes through a third boiler positioned between the power generation unit and the second boiler, the third boiler comprising a gas inlet, a water inlet, a gas outlet, and a steam outlet. The third boiler advantageously enables the recovery of heat from exhaust gases released by the power generation unit for the production of steam.

In further embodiments, a second flow path for steam connects the third boiler to the first steam flow path upstream of the second boiler. In this way, steam produced by the third boiler can be fed into the second boiler for generating high pressure, high temperature steam.

The system may additionally comprise one or more sensors for monitoring the temperature and/or the pressure of the steam and/or other gases.

In some embodiments, the system comprises a sensor for monitoring the temperature and/or pressure of the steam produced by the first boiler. A temperature sensor may be employed to ensure that the temperature of the steam does not exceed a predetermined threshold.

The system may comprise a sensor for monitoring the pressure of the water supplied to the first and/or third boiler.

The system may comprise a sensor for monitoring the temperature and/or pressure of the steam produced by the second boiler. This is useful to ensure that the steam has a sufficient temperature and pressure to drive the steam turbine for the production of electricity.

It may also be useful to monitor the temperature of the gases in the system. For example, a temperature sensor may be provided for monitoring the temperature of gas released by the gas outlet of the first boiler to ensure that the gas has been cooled sufficiently to avoid or minimize corrosion by contaminants present in the gas.

The system may further comprise one or more controllers for controlling the temperature and/or the pressure of the steam, the waste and/or exhaust gases, and/or the water supply. Conveniently, the controllers may be capable of automatically adjusting the temperature and/or the pressure of some or all of the fluids to be within predetermined limits in response to information received from the sensors. Alternatively, it may be possible to adjust the temperature and/or pressure of the fluids manually.

### DETAILED DESCRIPTION OF THE INVENTION

Embodiments of the invention will now be described with reference to the accompanying Figure in which is a schematic diagram of a waste gas management system in accordance with an embodiment of the present invention.

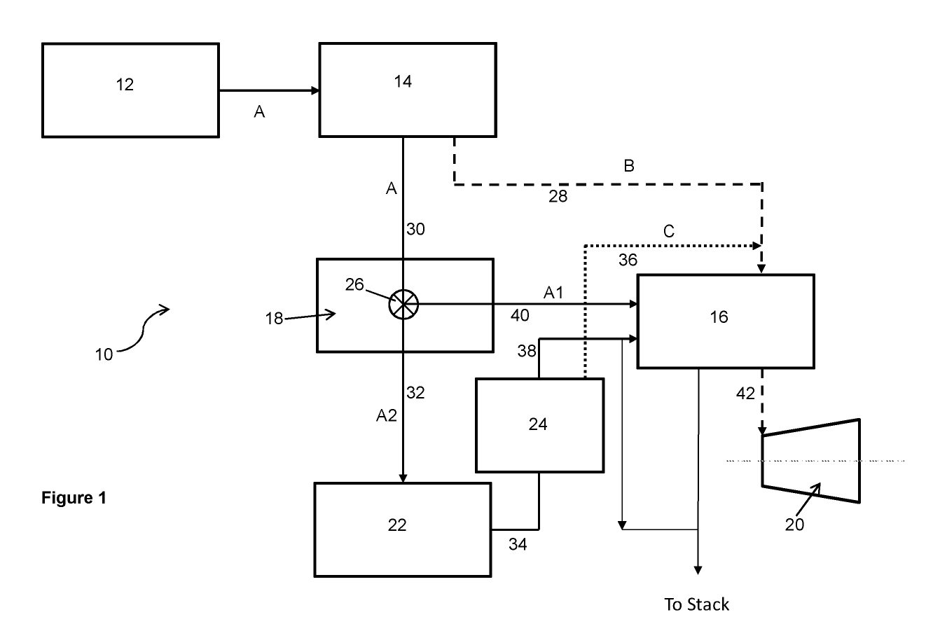

With reference to FIG. 1, a waste gas management system 10 comprises a gasification or pyrolysis unit 12, a first heat recovery boiler 14, a second boiler 16, a cleaning apparatus 18, and a steam turbine 20. The system 10 additionally comprises a power generation plant 22 and a third boiler 24, all being connected by conduits defining the various flowpaths.

A first flow path A for the transfer of gas is provided from the gasification unit 12, through the first boiler 14 and on to the cleaning apparatus 18. At this point the flow path A branches into a first branch A1, which leads directly to the second boiler 16, and a second branch A2 which leads to the second boiler 16 via the power generation plant 22 and the third boiler 24. A computer controlled valve 26 is positioned at the point of divergence between the first and second branches A1, A2.

A second flow path B for the transfer of steam is provided from the first boiler 14 to the steam turbine 20, via the second boiler 16. The second flow path B is fed by a further flow path C, which is supplied by the third boiler 24.

In use, waste gas (syngas) produced by the gasification unit 12 travels along the first flow path A to the first boiler 14, where heat is recovered from the waste gas to produce a first flow of high pressure, low temperature steam and cooled waste gas. The first flow of steam exits the first boiler 14 via a steam outlet and is transferred to the second boiler 16 via a pipe 28.

The cooled syngas is transferred from the first heat recovery boiler 14 via a pipe 30 to the cleaning apparatus 18, in which contaminants are removed from the syngas.

A first portion of the clean syngas is supplied by a pipe 32 (along flow path A2) to a power generation plant 22. The power generation plant 22 may be, for example, an internal combustion engine, or a gas turbine, which converts the clean syngas directly into electricity. Exhaust gases released from the power generation plant 22 are directed via a pipe 34 to a third boiler 24. The third boiler 24 recovers heat from the exhaust gases to produce a second flow of steam, which is supplied through a conduit 36 (along flowpath C) and combined with the first flow of steam before being passed into the second heat recovery boiler 16. Cooled exhaust gases released by the third boiler 24 are also supplied via a pipe 38 to the second heat recovery boiler 16 for burning.

A second portion of the clean syngas produced by the cleaning apparatus 18 is directed via a pipe 40 to the second heat recovery boiler 16 (along flowpath A1), where it is burned together with the cooled exhaust gases from the third boiler 24. The energy released is used to heat the combined first and second flows of steam supplied by the first and third boilers 14, 16. The second heat recovery boiler 16 releases high temperature, high pressure steam which is supplied via a pipe 42 to a steam turbine 20 for generating electricity. Flue gases from the second and third boilers 16, 24 are diverted to a stack.

The computer controlled valve 26 is adjusted to vary the proportion of gas passing along flowpaths A1 and A2. In this way, the proportion of syngas being combusted to generate electricity directly in the power generation plant can be balanced against the use of syngas to generate electricity indirectly through the steam turbine 20. It has been found that by managing the syngas according to the method and system of the invention, energy recovery is maximized to achieve an efficiency of 32-33%, as compared to just 27% for conventional energy recovery systems.

1-28. (canceled)

29. A method for producing steam, the method comprising:
(a) passing waste gas through a first boiler to produce steam having a first temperature, and cooled waste gas;
(b) removing contaminants from the cooled waste gas to produce clean waste gas;
(c) passing the steam having a first temperature through a second boiler; and
(d) burning at least a portion of the clean waste gas in the second boiler to produce steam having a second temperature, the second temperature being higher than the first temperature.

30. The method of claim 29, further comprising an initial step of gasifying waste organic material to produce waste gas.

31. The method of claim 29, wherein the waste gas used in step (a) has a temperature of at least 400° C.

32. The method of claim 29, additionally comprising monitoring the first temperature and/or the pressure of the steam obtained in step (a).

33. The method of claim 32, further comprising controlling the first temperature and/or pressure of the steam obtained in step (a).

34. The method of claim 29, wherein the steam has a first temperature of no more than 400° C.

35. The method of claim 29, wherein the steam produced in step (a) has a pressure of at least 40 bar.

36. The method of claim 29, wherein the second temperature is at least 450° C.

37. The method of claim 29, comprising burning a first portion of clean waste gas in the second boiler and supplying a second portion of clean waste gas to power generation equipment, such as an internal combustion engine or a gas turbine, for the direct production of electricity.

38. The method of claim 37, further comprising adjusting the ratio of the first portion of clean waste gas supplied to the second boiler to the second portion of clean waste gas supplied to the power generation equipment.

39. The method of claim 37, additionally comprising passing exhaust gases from the power generation equipment through a third boiler, thereby obtaining a second batch of steam and cooled exhaust gases.

40. The method of claim 39, further comprising passing the second batch of steam through the second boiler.

41. The method of claim 39, comprising passing the cooled exhaust gases produced by the third boiler to the second boiler where they are burned.

42. The method of claim 29, further comprising using the steam obtained in step (d) to drive a turbine to generate electricity.

43. A waste-to-energy system comprising:
a reactor for gasifying organic waste to produce waste gas;
a first boiler comprising a gas inlet, a water inlet, a gas outlet, and a steam outlet;
a cleaning apparatus;
a second boiler comprising a gas inlet, a gas outlet, a steam inlet and a steam outlet; and
a steam turbine comprising a steam inlet,
wherein a flow path for gas is provided from the reactor to the second boiler via the first boiler and the cleaning apparatus, and a first flow path for steam is provided from the first boiler to the steam turbine via the second boiler.

44. The system of claim 43, wherein the cleaning apparatus comprises a gas inlet, which is fed by the gas outlet of the first boiler, and a gas outlet.

45. The system of claim 43, wherein the gas inlet of the second boiler is connected to the gas outlet of the cleaning apparatus and the steam inlet is connected to the steam outlet of the first boiler.

46. The system of claim 43, wherein the gas flow path is branched at or just after the cleaning apparatus, wherein a first branch is provided between the cleaning apparatus and the second boiler, and a second branch is provided between the cleaning apparatus and a power generation unit.

47. The system of claim 46, wherein the power generation unit comprises a gas inlet and a gas outlet, the gas inlet being connected to the gas outlet of the cleaning apparatus.

48. The system of claim 46, further comprising a controller for controlling the distribution of gas between the first and second branches.

49. The system of claim 48, wherein the controller comprises a valve positioned at the point at which the first flow path branches.

50. The system of claim 48, additionally comprising a control unit which is operatively linked to the controller whereby to automatically adjust the distribution of gas flow between the first and second branches.

51. The system of claim 46, wherein the second branch is provided from the cleaning apparatus to the second boiler, via the power generation unit.

52. The system of claim 51, wherein the second branch additionally passes through a third boiler positioned between the power generation unit and the second boiler.

53. The system of claim 52, wherein a second flow path for steam connects the third boiler to the first steam flow path upstream of the second boiler.

54. The system of claim 43, additionally comprising one or more sensors for monitoring the temperature and/or the pressure of the steam and/or other gases.

55. The system of claim 54, further comprising one or more controllers for controlling the temperature and/or the pressure of the steam, the waste and/or exhaust gases, and/or the water supply.

56. The system of claim 55, wherein the controllers are configured to automatically adjust the temperature and/or the pressure of some or all of the fluids to be within predetermined limits in response to information received from the sensors.
